(19) United States
(12) Patent Application Publication
(10) Pub. No.: US 2009/0091422 A1
(43) Pub. Date: Apr. 9, 2009

(54) DEVICE IDENTIFICATION VIA SERIAL COMMUNICATION LINK

(75) Inventors: Jahan Minoo, South San Francisco, CA (US); Paul Holden, Sunnyvale, CA (US); Stan Rabu, Sunnyvale, CA (US); Jeff Terlizzi, San Francisco, CA (US); Jesse Dorogusker, Los Altos, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/203,717

(22) Filed: Sep. 3, 2008

Related U.S. Application Data
(60) Provisional application No. 60/977,206, filed on Oct. 3, 2007.

(51) Int. Cl. G05B 19/00

(52) U.S. Cl. 340/5.8; 370/254

(57) ABSTRACT

Systems and methods are provided that enable identification of an accessory device or other peripheral device via a serial communication link. An electronic device (e.g., a media player or portable media device) may identify an accessory device using a serial communication link when the accessory device is attached or coupled to the electronic device. Based on serial communications, for example, the electronic device may discover and identify an accessory device to determine whether one or more preferences or functionalities should be set or enabled. The electronic device may also discover whether an accessory device or its manufacturer, distributor, or retailer is authorized or licensed to enable certain functionalities or set certain preferences when connect to the electronic device. Therefore, aspects of a serial communication link that may already exist in many electronic devices for data communication usage may be repurposed to provide identification or authorization of accessories or other peripheral devices.

### CROSS-REFERENCES TO RELATED APPLICATIONS

This applications claims the benefit of and priority to U.S. Provisional Patent Application No. 60/977,206, filed Oct. 3, 2007 and entitled “Device Identification via Serial Communication Link,” the entire disclosure of which is herein incorporated by reference for all purposes.

### FIELD OF THE INVENTION

The present invention relates generally to identification of electronic devices. More particularly, to techniques for identification of electronic devices using a serial communication link.

### BACKGROUND OF THE INVENTION

Electronic devices, such as personal computers, laptops, media players, portable media devices, cellular phones, personal digital assists (PDAs), or the like, are prevalent in today's marketplace. Peripherals and accessories to these electronic devices, such as docking stations and A/V cables, can also be commonplace. As competition in the marketplace of consumer electronics and personal computers becomes ever more heated, consumers have become more demanding in terms of both the functionality and use for electronic devices and their associated accessories.

One function that may be popular with electronic devices, such as media players or portable media devices, can be the storage and playback of content or other media assets, such as music, images, photos, and movies. An electronic device may include a communications interface, such as a serial communication link, that allows a user to upload the content or other media assets for storage. Compression and encoding methods, such as MPEG-standards for audio and video, can result in less storage capacity being required by an electronic device, and making potentially making it more convenient and attractive to store tens of thousands of songs and photos, hours of audio books, and several full-length DVD quality movies. Moreover, multimedia content or other media assets can more easily be obtained from distribution sources, such as via the Internet, hot spots, or other electronic retailers.

Accessories or other peripheral devices can also be used to expand capabilities and usability of an electronic device. In the case of an MP3 player, such as the iPod® made by Apple, Inc of Cupertino, Calif. for example, (or, for that matter, any other digital media playback device), a number of accessories can be connected to the MP3 player to provide extended or desired functionalities, such as audio recording, AM/FM broadcasting, speaker output, or the like that may improve usability of the MP3 player to the user. These accessories can range from simply cables to complex docking stations for interfacing with car audio or home theater systems. With an ever expanding number of accessories that can expand the functionalities provided by electronic devices, the mechanisms and processes of updating an electronic device to accept and interact with every accessory on the market can become nearly impossible.

Accordingly, what is desired are improved methods and apparatus for solving some of the problems, and reducing some of the drawbacks, with the identification between a electronic device and an accessory device.

### BRIEF SUMMARY OF THE INVENTION

In various embodiments, an electronic device such as a media player or portable media device may attempt to identify an accessory device using a serial communication link of the electronic device. As a result, the electronic device may determine what preferences or functionalities of the electronic device may be enabled for use by the accessory device. The electronic device may also discover whether an accessory device (or its manufacturer, distributor, or retailer) is authorized or licensed to enable/disable certain functionalities of the electronic device or set/unset certain preferences when connect to the electronic device.

In some embodiments, an accessory device can identify itself to an electronic device using a serial communication link when the accessory device is attached to or coupled with the electronic device. By taking advantage of characteristics or properties of serial communications, for example, an accessory device can communicate identifying information to an electronic device using a serial communication link without having to rely on a processors or other microcontroller to perform a more complex protocol for accessory device identification. Additionally, legacy electronic device with an existing serial communication link may be able to take advantage of newer accessory device that utilize the serial communication link for accessory device identification. Therefore, aspects of a serial communication link that may already exist in many electronic devices for data communication usage may be repurposed to provide identification or authorization of accessories or other peripheral devices. Accordingly, an accessory device incorporating an embodiment disclosed herein may be designed to include simpler, less expensive circuitry while still allowing the accessory device to communicate identification information to electronic devices having an existing serial communication link.

In one embodiment, an accessory device can include circuitry that indicates to an electronic device that the accessory device provides identifying information via a serial communication link in the form of a single identification pulse. The accessory device can further include circuitry that transmits the identification pulse over the serial communication link. The accessory device can transmit the identification pulse in response to a pulse sent over the serial communication link from the electronic device to initiate accessory identification. For example, upon detecting the presence of the accessory device, the electronic device may generate pre-determined data to be transmitted over the serial communication link to the accessory device. The electronic device may transmit the data in the form of a single pulse over the serial communication link to begin accessory identification.

In one aspect, the electronic device may monitor the serial communication link after sending the pulse to initiate accessory identification. The electronic device may automatically sample the identification pulse sent from the accessory device to determine features or characteristics of the pulse, such as speed or timing. The electronic device may utilize the determined features or characteristics of the identification pulse to then identify the accessory device. For example, a given speed or timing of an identification pulse sent from an accessory device may indicate the type, class, manufacture, or the like, of the accessory device. In response to identifying the accessory device, the electronic device may determine the appropriate preferences or functionalities that need to be set/unset or enabled/disable for the accessory device. Accordingly, in various embodiments, features or characteristics not used to convey extended data of individual pulses or signals sent from an accessory device via a serial communication link of an electronic device may be utilized to identify the accessory device.

In another aspect, an electronic device, such as a media player or portable media device, may extract information from an accessory device. In one embodiment, an accessory device may include circuitry that indicates to an electronic device that the accessory device provides identifying information via a serial communication link when “clocked out” by the electronic device. The accessory device may include circuitry that outputs a bit stream over the serial communication link in response to a clock signal generated by the electronic device and sent over the serial communication link.

For example, the electronic device may generate data representing a virtual clock. The electronic device may transmit this virtual clock (e.g., as repetitive data transmission) over the serial communication link to the accessory device. The accessory device may transmit identifying information (e.g., an identification tag) back to the electronic device in the form of a bit stream or packet. The bit stream may be “clocked out” of the accessory device, bit-by-bit, in a temporally aligned manner over the serial communication link responsive to the serial data transmissions of the electronic device representing the clock signal. The bit stream may be formatted such that a serial communications interface or UART of the electronic device can properly understand the bit stream or packet send from the accessory device to identify the accessory device.

Thus, in some embodiments, a tightly coupled causal relationship may be provided between bit stream of identifying information being output by an accessory device and a virtual clock signal sent by an electronic device using data transmissions of a serial communication link. Accordingly, a serial communication link of an electronic device may be utilized to identify an accessory device by essentially “clocking” the identifying information out of a passive accessory device.

A further understanding of the nature and the advantages of the inventions disclosed herein may be realized by reference of the remaining portions of the specification and the attached drawings.

### BRIEF DESCRIPTION OF THE DRAWINGS

In order to better illustrate and describe examples and/or embodiments of those inventions found within the specification, reference may be made to the accompanying drawings. The additional details used to describe the accompanying drawings should not be considered as limitations to the scope of any of the disclosed inventions, the presently described examples and/or embodiments of the inventions, and/or the presently understood best mode of the inventions.

FIG. 1 is a block diagram of a media player that may incorporate embodiments of the present invention;

FIG. 2 is a block diagram of a system for device identification in one embodiment according to the present invention;

FIG. 3 is a simplified flowchart of a method for identifying an accessory device in one embodiment according to the present invention;

FIG. 4 is a flowchart of a method for using pulses to identify an accessory device in one embodiment according to the present invention;

FIG. 5 is a message sequence chart illustrating communication for identification using pulses in one embodiment according to the present invention;

FIG. 6 is a block diagram of identification circuitry in one embodiment according to the present invention;

FIG. 7 is a flowchart of a method using a bit stream to identify an accessory device in one embodiment according to the present invention;

FIG. 8 is a message sequence chart illustrating communication for identification using a bit stream in one embodiment according to the present invention; and

FIG. 9 is a simplified block diagram of a computer system that may incorporate embodiments of the present invention.

### DETAILED DESCRIPTION OF THE INVENTION

In various embodiments, an electronic device can be configured to identify an accessory device or other peripheral device using a serial communication link. An electronic device (e.g., a media player or portable media device) may identify an accessory device using a serial communication link when the accessory device is attached or coupled to the electronic device. Based on serial communications, for example, between the electronic device and the accessory device, the electronic device may discover and identify the accessory device to determine whether one or more preferences or functionalities (e.g., media playback) of the electronic device should be set/unset or enabled/disabled. The electronic device may also discover whether an accessory device or its manufacturer, distributor, or retailer is authorized or licensed to enable certain functionalities or set certain preferences when connect to the electronic device. Therefore, aspects of a serial communication link that may already exist in many electronic devices for data communication usage may be repurposed to provide identification or authorization of accessories or other peripheral devices.

In some embodiments, an accessory device can identify itself to an electronic device using a serial communication link when the accessory device is attached to or coupled with the electronic device. By taking advantage of characteristics or properties of serial communications, for example, an accessory device can communicate identifying information to an electronic device using a serial communication link without having to rely on a processors or other microcontroller to perform a more complex protocol for accessory device identification. Additionally, legacy electronic device with an existing serial communication link may be able to take advantage of newer accessory device that utilize the serial communication link for accessory device identification. Therefore, aspects of a serial communication link that may already exist in many electronic devices for data communication usage may be repurposed to provide identification or authorization of accessories or other peripheral devices. Accordingly, an accessory device incorporating an embodiment disclosed herein may be designed to include simpler, less expensive circuitry while still allowing the accessory device to communicate identification information to electronic devices having an existing serial communication link.

In one embodiment, an accessory device can include circuitry that indicates to an electronic device that the accessory device provides identifying information via a serial communication link in the form of a single identification pulse. The accessory device can further include circuitry that transmits the identification pulse over the serial communication link. The accessory device can transmit the identification pulse in response to a pulse sent over the serial communication link from the electronic device to initiate accessory identification. For example, upon detecting the presence of the accessory device, the electronic device may generate pre-determined data to be transmitted over the serial communication link to the accessory device. The electronic device may transmit the data in the form of a single pulse over the serial communication link to begin accessory identification.

In another aspect, an electronic device, such as a media player or portable media device, may extract information from an accessory device. In one embodiment, an accessory device may include circuitry that indicates to an electronic device that the accessory device provides identifying information via a serial communication link when “clocked out” by the electronic device. The accessory device may include circuitry that outputs a bit stream over the serial communication link in response to a clock signal generated by the electronic device and sent over the serial communication link.

Aspects of the environments within which various examples and/or embodiments of those invention found within the specification operate will first be described.

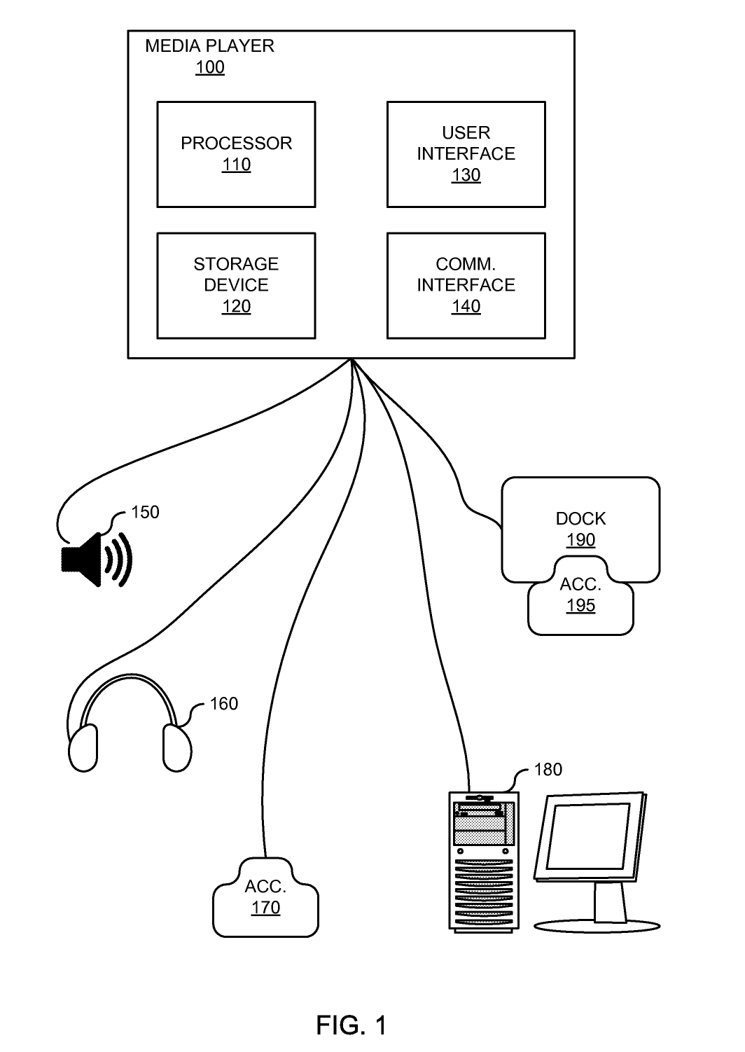

FIG. 1 is a block diagram of media player 100 that may incorporate embodiments of the present invention. In general, a media player stores content and/or media assets, such as audio tracks, movies, or photos that can be played or displayed on the media player using a media playback subsystem. One example of media player 100 can be the iPod® media player, which is available from Apple, Inc. of Cupertino, Calif. Another example of media player 100 can be a personal computer, such as a laptop or desktop.

In this example, media player 100 includes processor 110, storage device 120, user interface 130, and communications interface 140. Processor 110 can control various functionalities associated with media player 100. Media play 100 may output audio content, video content, image content, and the like. Media player 100 may also output metadata or other information associated with content, such as track information and album art.

Typically, a user may load or store content onto media player 100 using storage device 120. Storage device 120 can include read-only memory (ROM), random access memory (RAM), non-volatile memory, flash memory, floppy disk, hard disk, or the like. A user may interact with user interface 130 of media player 100 to view or consume content. Some examples of user interface 130 can include buttons, click wheels, touch pads, displays, touch screens, and other input/output devices.

Media player 100 can include one or more connectors or ports that can be used to load content, retrieve content, interact with applications running on media player 100, interface with external devices, and the like. In this example, media player 100 includes communications interface 140. Some examples of communications interface 140 can include universal serial bus (USB) interfaces, IEEE 1394 (or FireWire/iLink®) interfaces, universal asynchronous receiver/transmitters (UARTs), wired and wireless network interfaces, transceivers, and the like. Media player 100 may connect to devices, accessories, private and public communications networks (e.g., the Internet), or the like, using communications interface 140.

In one example, media player 100 can be coupled via a wired and/or wireless connector or port to output audio and/or other information to speakers 150. In another example, media player 100 may be coupled via a wired and/or wireless connector or port to output audio and/or other information to headphones 160. In yet another example, media player 100 may be coupled via a wired and/or wireless connector or port to interface with an accessory 170 or a host computer 180. The same connector or port may enable different connections at different times.

Media player 100 can be physically inserted into docking system 190. Media player 100 may be coupled via a wired and/or wireless connector or port to interface with docking system 190. Docking system 190 may also enable one or more accessory devices 195 to couple with wires or wirelessly to interface with media player 100. Many different types and functionalities of accessory devices 170 and 195 can interconnect to or with media player 100. For example, an accessory device may allow a remote control to wirelessly control media player 100. As another example, an automobile may include a connector into which media player 100 may be inserted such that an automobile media system can interact with media player 100, thereby allowing media content stored on media player 100 to be played within the automobile.

In various embodiments, media player 100 can receive content or other media assets from a computer system (e.g., host computer 160). The computer system may serve to enable a user to manage media assets stored on the computer system and/or stored on media player 100. As an example, communications interface 140 may allow media player 100 to interface with host computer 160. Host computer 160 may execute a media management application to manage media assets, such as loading songs, movies, photos, or the like, onto media player 100. The media management application may also create playlists, record or rip content, schedule content for playback or recording, or the like. One example of a media management application can be iTunes®, produced by Apple, Inc. of Cupertino, Calif.

Accessories or peripheral devices may identify themselves to media player 100 by communicating using one or more formalized protocols. One example of an accessory protocol can be the iPod Accessory Protocol (iAP), provided by Apple, Inc. of Cupertino, Calif. These accessories may include a processor or other microcontroller that can enable such communication using the formal protocols. The inclusion of the circuitry, such as the microcontroller, to support accessory identification and authorization using formalistic or complex protocols can increase the cost of the accessory.

In various embodiments, a media player (e.g., media player 100) may attempt to identify an accessory device when the accessory device is attached to the media player. For example, the type or class of accessory may dictate whether one or more functionalities are enabled or whether one or more preferences associated with media player 100 are set. In some embodiments, media player 100 may determine whether the accessory device is authorized or licensed to enable or request functionalities when connected. Simple peripheral devices or accessories, such as audio or video cables, that may not require the power of a processor or microcontroller to negotiate with another electronic device to function, can utilize existing interfaces and communication links of the electronic device for the purposes of achieving device identification with circuitry that can take advantage of aspects of a serial communication link.

In some embodiments, an accessory device can initially identify itself when attached to media player 100 by presenting one or more of a set of predetermined values to media player 100 via a first interface. The accessory device may present a predetermined value indicating to media player 100 that the accessory device supports identification via a second interface, such as a serial communication link or UART. In one example, media player 100 can include a 30 pin connector, of which one or more of the pins of the 30 pin connector are designated as the first interface for the purposes of identification of accessories and another one or more pins are designated as the second interface for serial communication, (e.g., associated with a serial communication interface or UART).

In some embodiments, when an accessory device may present itself to media player 100 for identification, media player 100 may generate a pulse using the serial communication link to the accessory. The accessory device can send a single return pulse over the serial communication link to media player 100. Media player 100 may automatically sample the pulse to determine the speed of baud associated with the pulse. Media player 100 may utilize the determined speed or timing of the pulse to identify the type or class of the accessory. Accordingly, the UART of media player 100 is utilized to identify information from a characteristic usually not used to convey data.

In further embodiments, media player 100 may directly extract information from an entirely passive accessory. For example, media player 100 may generate a signal (e.g., data sent serially and formatted to represent a clock signal) to be sent to the accessory device via the serial communication link. In response to the signal sent over the serial communication link, the accessory device may send a bit stream, bit-by-bit, in a temporally aligned manner over the serial communication link responsive to the signal. The data bit stream may be formatted such that the serial communication link or UART of media player 100 can properly understand the data packets pushed our by the signal from media player 100. Media player 100 then may identify the type or class of the accessory from the data. Accordingly, an accessory device may only require sufficient circuitry to generate the bit stream responsive to media player 100. Thus, there may be a tightly coupled causal relationship between the output bit stream, and the activity going on inside the accessory device in response to a clock signal sent by media player 100.

Accordingly, an accessory device may be configured to utilize pre-existing communication mechanisms associated with media player 100. This allows accessories or other peripheral devices to be manufactures at low cost because simpler circuitry is required. Additionally, in various embodiments, previously manufactured devices may be backward compatible with newly developed accessories in a simple low-cost manner to enable one or more functionalities or set one or more preferences associated with mutual operation between media player 100 and an accessory.

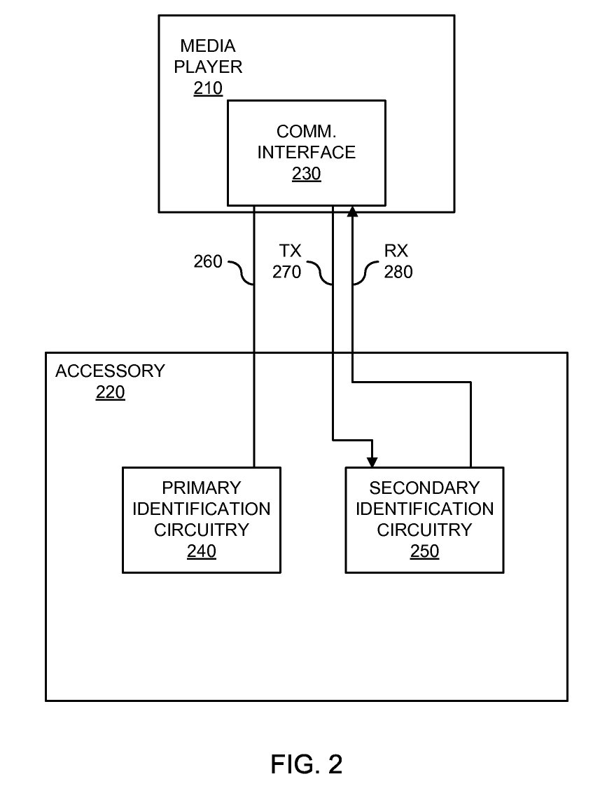

FIG. 2 is a block diagram of system 200 for device identification in one embodiment according to the present invention. System 200 can include media player 210 and accessory 220. Media player 210 may be embodied as media player 100 of FIG. 1. In this example, media player 210 can include communication interface 230 (e.g., a serial UART interface). Communications interface 230 can include hardware and/or software elements configured for exchanging information. In some embodiments, communication interface 230 may provide serial UART communication between media player 210 and accessory 220.

Serial communication using communication interface 230 may include transmissions of one or more pulses. A pulse may include a transition from a one state (e.g., positive voltage level) to another state (e.g., a negative voltage level) followed by another return transition. A pulse may represent a data unit or bit. In some embodiments, serial communication may include a “start” bit, followed by five to eight data bits, which may be least-significant-bit first, followed by an optional “parity” bit, and then followed by one or more “stop” bits (e.g., [idle=one or more 1s] [start bit=0] [8 data bits] [stop bit=1] [idle]). A start bit may be the opposite (e.g., in polarity) of the data-line's idle state. The stop bit can be the data-line's idle state, and may provide a delay before the next character can start. The parity bit may either make the number of “one” bits between any start/stop pair odd, or even, or it can be omitted.

In various embodiments, timing of a data bit may be used to convey information to media player 210. Accordingly, the same data (e.g., [start bit] [1111] [stop bit]) sent over a serial communication link at different speeds (e.g., 300 b/s and 600 b/s) may be interpreted by media player 210 to mean different things. For example, the data [start bit] [1111] [stop bit] sent at 300 b/s may indicate that a first class or type of accessory 220 is coupled to media player 210. The data [start bit] [1111] [stop bit] sent at 600 b/s may indicate that a second class or type of accessory 220 is coupled to media player 210. Media player 210 may be configured to match the data received via communications interface 230 and the timing or rate at which the data was sent to various types, classes, configurations, or the like of accessories or other peripheral devices.

In this example, accessory 220 can include primary identification circuitry 240 and secondary identification circuitry 250. Primary identification circuitry 240 and secondary identification circuitry 250 may be linked to media player 210 via communications interface 230. In some embodiments, primary identification circuitry 240 and/or secondary identification circuitry 250 may be implemented as integrated circuits.

Primary identification circuitry 240 can include hardware and/or software elements configured to indicate to an electronic device that an accessory device or peripheral device is present. Primary identification circuitry 240 may also indicate or otherwise identify one or more forms of identification or authorization protocols supported by the electronic device. One example of primary identification circuitry 240 may be a set of resistors that present a predetermined resistor value to media player 210 when enabled. The predetermined resistor value may indicate to media player 210 that the accessory device will provide identification information using a serial communication link or UART. Media player 210 may select one or more other identification or authorization protocols to use for communicating with accessory 220.

Secondary identification circuitry 250 can include hardware and/or software elements configured to identify an accessory device or peripheral device to an electronic device. Secondary identification circuitry 250 may include circuitry that generates information indicative of an identifier, type, or class of accessory. Some examples of secondary identification circuitry 250 that may be incorporated in accessory 220 can be microcontrollers, timers, oscillators, mono-stable multivibrators, pulse generators, shift registers, or the like.

In one example of operation, primary identification circuitry 230 may provide to media player 210 an “Extended Identification Resistor” value via communications interface 230. The extended identification resistor value may indicate to media player 210 that accessory 220 is capable of performing an extended identification method or protocol to generate an “Extended Identification Tag” via a serial communication link between media player 210 and accessory 220. Accessory 220 may identify itself to media player 210 using secondary identification circuitry 240 to transmit the extended identification tag via communication interface 230.

In various embodiments, using the extended identification method or protocol, a transmit data port (TX) 260 of communication interface 230 associated media player 210 can be coupled to one or more inputs associated with secondary identification circuitry 240. A receive data port (RX) 270 of communication interface 230 associated with media player 210 may be coupled to one or more outputs associated with secondary identification circuitry 240. Transmit data port 260 and receive data port 270 may provide communication serially, in parallel, or the like. In one embodiment, communication interface 230 can provide the ability to receive and transmit serial data using different serial bit rates. Some examples of different serial bit rates are 115200, 230400, 460800, and 921600 bit/s. Accordingly, the circuitry required in secondary identification circuitry 240 to identify accessory 220 via a serial communication link may be less complex and hence less costly than the additional circuitry required to communicate with media player 210 using more complex protocols.

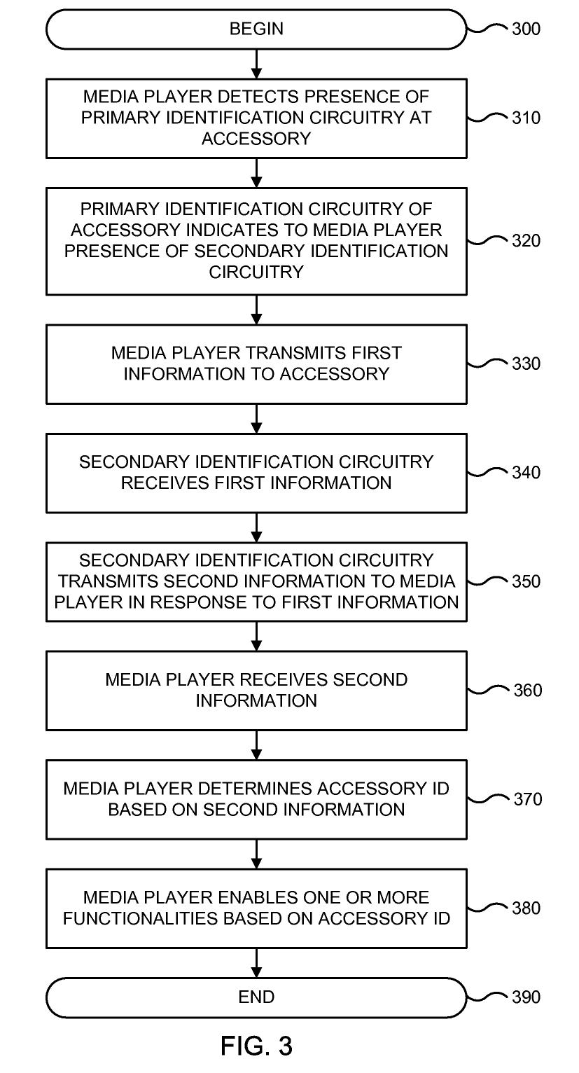

FIG. 3 is a simplified flowchart of a method for identifying an accessory device in one embodiment according to the present invention. The processing depicted in FIG. 3 may be performed by software modules (e.g., instructions or code) executed by a processor, by hardware modules, or combinations thereof. FIG. 3 begins in step 300.

In step 310, a media player (e.g., media player 210 of FIG. 2) detects the presence of an accessory device (e.g., accessory 220). For example, media player 210 may detect the presence of accessory 220 in response to the extended identification resistor value created by primary identification circuitry 240. In step 320, primary identification circuitry 240 of accessory 220 indicates to media player 210 the presence of secondary identification circuitry 250.

In step 330, media player 210 transmits first information to accessory 220. The first information can include any signal, message, data, sequence, or the like, that indicates to an accessory device or other peripheral device to initiate an identification or authorization method of protocol with an electronic device. In one example, media player 210 may supply or otherwise generate one or more signal pulses send via communications interface 230 using a serial communication link to secondary identification circuitry 250 of accessory 220. In another example, the one or more signal pulses generate by media player 210 form a clock signal that can drive secondary identification circuitry 250. In step 340, secondary identification circuitry 250 receives the first information.

In step 350, secondary identification circuitry 250 transmits second information to media player 210 in response to the first information. The second information can include any signal, message, data, sequence, or the like, that identifies an accessory device or other peripheral device to an electronic device. For example, secondary identification circuitry 250 of accessory 220 may generate a single signal pulse in response to the first information. In another example, secondary identification circuitry 250 may generate a bit stream, bit-by-bit, in a temporally aligned manner responsive to a clock signal supplied by media player 210. In step 360, media player 210 receives the second information.

In step 370, media player 210 determines an accessory identifier associated with accessory 220 based on the second information. For example, media player 210 may consult a lookup table that maps the second information to an accessory identifier associated with accessory 220. In another example, media player 210 may process or decode the second information to obtain the accessory identifier.

In step 380, media player 210 enables one or more functionalities based on the accessory identifier. Functionalities can include applications, operating system services, hardware features, or the like. For example, media player 210 may set one or more preferences for outputting content or other media asserts, such as video data or audio data, on predetermined ports or lines associated with communication interface 230. This can allow the audio or video data to be further used or distributed by accessory 220. FIG. 3 ends in step 390.

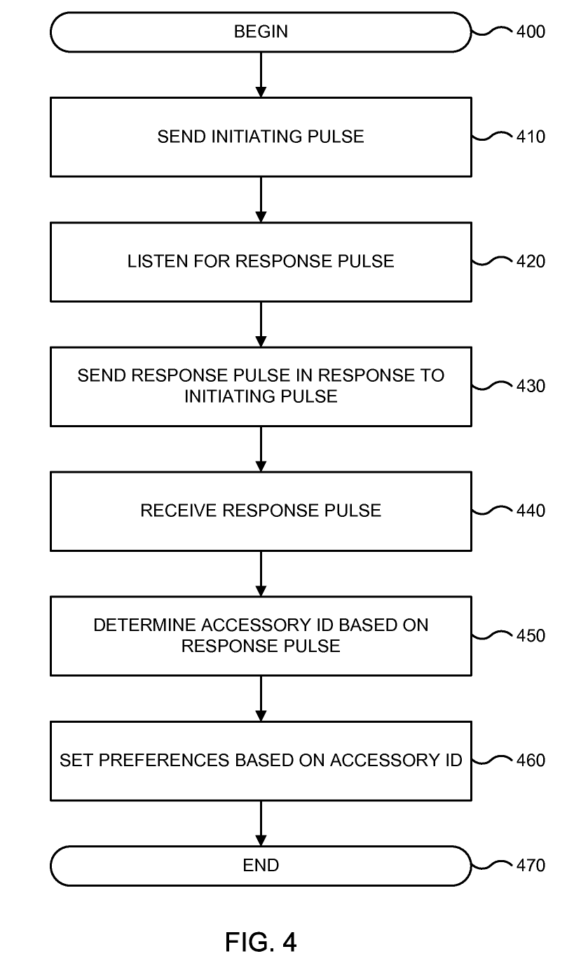

FIG. 4 is a flowchart of a method for using pulses to identify an accessory device (e.g., accessory 220 of FIG. 2) in one embodiment according to the present invention. FIG. 4 begins in step 400.

In step 410, an initiating or initiation pulse is sent. A pulse can include a transient change in the amplitude of a signal from a baseline value to a predetermined value different from the baseline value (e.g., higher or lower), followed by a return to the baseline value. A pulse may also include a change in some characteristic of a signal (e.g., phase or frequency) from a baseline value to a different value, followed by a return to the baseline value. For example, in some embodiments, media player 210 can generate a single pulse of a predetermined length. The predetermined length may indicate to accessory 220 that media player 210 can communicate via a serial communication link to identify accessory 220.

In step 420, media player 210 listens for a response or identification pulse. For example, media player 210 may enable various routines to auto detect or “auto baud” communications received by communication interface 230. In step 430, a response pulse is sent in response to the initiating pulse. For example, secondary identification circuitry 250 may received the initiating pulse, and generate in response one or more pulses of a predetermined length. In step 440, the response pulse is received.

In step 450, an accessory identifier is determined based on the response pulse. Media player 210 may match information associated with the pulse to an accessory identifier. For example, media player 210 may determine the speed or timing associated with the response pulse. The speed or timing may provide an indication as to the class or type of peripheral device which may be associated with the accessory identifier of accessory 220 coupled to media player 210.

In step 460, one or more preferences are set based on the accessory identifier. In various embodiments, media player 210 may include information establishing profiles. A profile may store settings for applications, operating systems, GUIs, hardware, and accessories or other peripheral devices. The profile may be associated with one or more accessory identifier. Media player 210 may “load” a profile upon identification of an accessory, setting preferences, options, features, or the like for operation with the accessory.

Accordingly, the method described above can enable an electronic device to identify an accessory device or peripheral device via a serial communication link. By auto-bauding an identification pulse received from the accessory, the electronic device can automatically enable functionalities or set preferences. FIG. 4 ends in step 470.

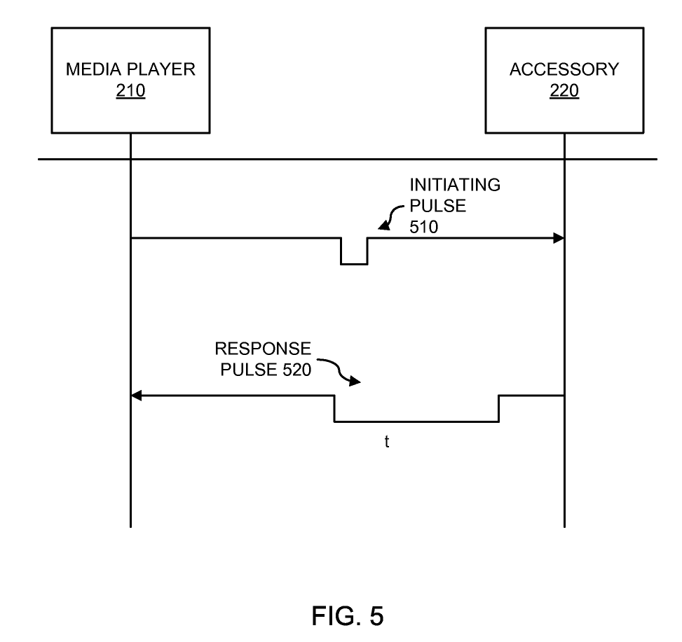

FIG. 5 is a message sequence chart illustrating communication for identification using pulses in one embodiment according to the present invention. In this example, media player 210 may see or otherwise detect an “Extended Identification Resistor” value on one or more pins of communication interface 230. In response, media player 210 may send an initiation pulse as a single initiating pulse 510 to accessory 220. Media player may transmit initiating pulse 510 over a transmit (TX) port associated with communication interface 230. The single pulse may be a simple transition from an idle state (e.g., on or high) to an off or low state, followed by a return to the idle state. Initiating pulse 510 may be designated to initiate a secondary identification method when received by accessory 220. Accessory 220 may receive initiating pulse 510 over a receive (RX) port associated accessory 220 linking accessory 220 to communication interface 230 of media player 210.

Based on initiating pulse 510, accessory 220 may produce an identification pulse as response pulse 520. Response pulse 520 may be a low-going pulse (e.g., a transition from one to off), followed by a return to an idle state. Response pulse 520 may be transmitted over a transmit (TX) port associated accessory 220 linking accessory 220 to communication interface 230 of media player 210. Media player 210 may receive response pulse 520 on a receive (RX) port associated with communication interface 230.

In various embodiments, response pulse 520 may be generated by an integrated circuit embodied as secondary identification circuitry 250 of accessory 220. In one embodiment, secondary identification circuitry 250 may include pulse detection circuitry configured to detect initiating pulse 510 and pulse generation circuitry configured to generate response pulse 520. Secondary identification circuitry 250 can include control circuitry in the form of “one shot” circuitry, such as a “555 timer” or a mono-stable multivibrator to generate response pulse 520. The timed duration of response pulse 520 can be indicative of an extended identification value. Media player 210 may measure the extended identification value through an auto-baud capability. In various embodiments, using an auto-baud capability places the duration of response pulse 520 into one of many possible “buckets” of identification values. The granularity and tolerances of these buckets may be defined by accuracy associated with the auto-baud capability.

In some embodiments, secondary identification circuitry 250 of accessory 220 may include other types of circuitry configured to generate the “Extended Identification Tag.” For example, accessory 220 may include passive circuitry. The passive circuitry may generate identification information in response to being driven by data sent from media player 210 via a serial communication link.

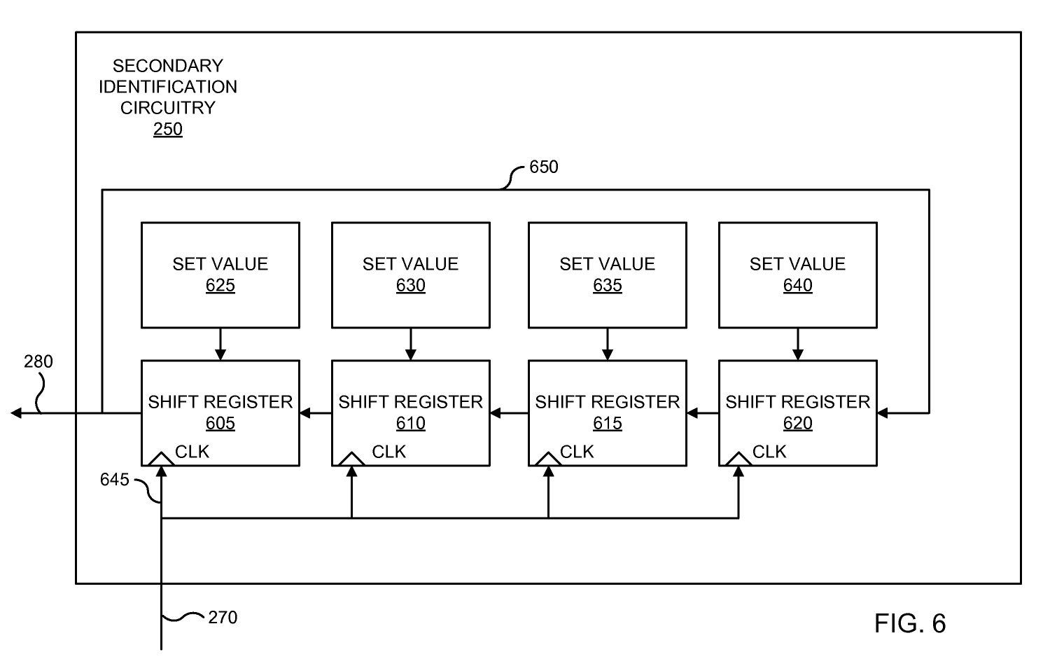

FIG. 6 is a block diagram of secondary identification circuitry 250 in one embodiment according to the present invention. In this example, secondary identification circuitry 250 can include shift registers 605, 610, 615, and 620 and set value blocks 625, 630, 635, and 640. Shift registers 605, 610, 615, and 620 may include hardware and/or software elements configured to be connected together in such a way that data is shifted down the line when shift registers 605, 610, 615, and 620 are activated. Set value blocks 625, 630, 635, and 640 may include hardware and/or software elements configured to provide a set, predetermined, or expected value.

Set value block 625 is linked to shift register 605, and may operate to load a set or predetermined value into shift register 605. Set value block 630 is linked to shift register 610, and may operate to load a set or predetermined value into shift register 610. Set value block 635 is linked to shift register 615, and may operate to load a set or predetermined value into shift register 615. Set value block 640 is linked to shift register 620, and may operate to load a set or predetermined value into shift register 620.

An output associated with shift register 605 can be linked to RX port 280 of communication interface 230 of media player 210 in FIG. 2, and also may be linked to an input associated with shift register 620 via line 650. An output associated with shift register 610 can be linked to an input associated with shift register 605. An output associated with shift register 615 can be link to an input associated with shift register 610. An output associated with shift register 620 can be linked to an input associated with shift register 615. A clock signal may be supplied via line 645 to shift registers 605, 610, 615 and 620. The clock signal may be driven over TX port 270 of communication interface 230 of media player 210.

In one example of operation, shift registers 605, 610, 615 and 620 can output a bit stream or data packet. The bit stream or packet can representing data obtained from set value blocks 625, 630, 635, and 640. The output bit stream or packet may be supplied to media player 210 for the purposes of identifying accessory 220.

In various embodiments, to simplify the operation of shift registers 605, 610, 615 and 620, media player 210 may generate a clock signal that drives shift registers 605, 610, 615 and 620 to output the bit stream or packet. Media player 210 may generate a virtual clock signal over a serial communication link between media player 210 and accessory 220. The virtual clock signal can be formed by data serially transmitted to oscillate between a high and a low state, with a 50% duty cycle, and may take the form of a square wave.

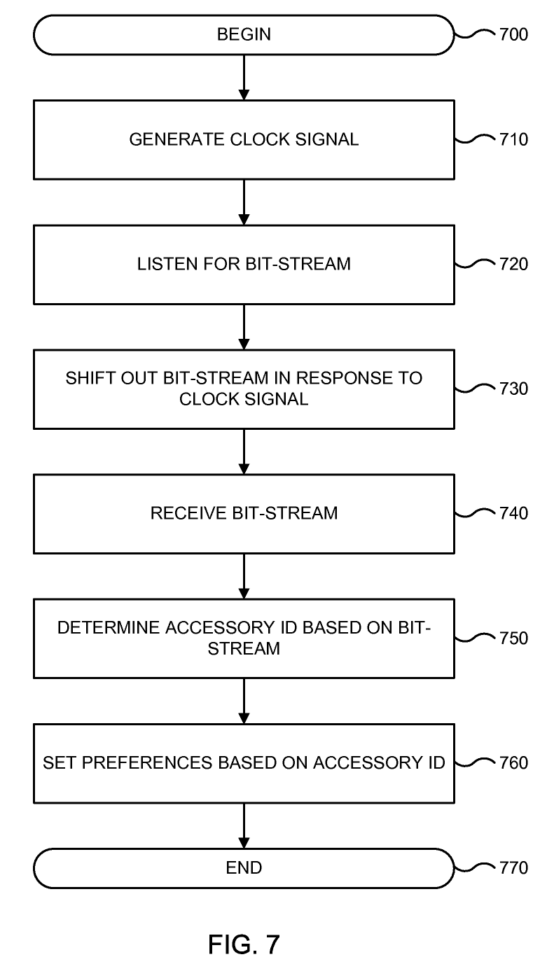

FIG. 7 is a flowchart of a method using a bit stream to identify accessory 220 in one embodiment according to the present invention. FIG. 7 begins in step 700.

In step 710, media player 210 provides a clock signal. In one example, media player 210 may transmit data using a serial communication link. Media player 210 may transmit serial data representing “0x55.” The serial data in this form can provide a clock signal that oscillates between a high and a low state, with a 50% duty cycle, and may take the form of a square wave to secondary identification circuitry 250. In step 720, media player 210 listens for a bit stream.

In step 730, secondary identification circuitry 250 uses shift registers 605, 610, 615 and 620 to shift out a bit stream in response to the clock signal. Based on the clock signal being driven over the serial communication link, bits are clock out of shift registers 605, 610, 615 and 620 into a bit stream over the serial communication link. In step 740, media player 210 receives the bit stream. In step 750, media player 210 determines an accessory identifier based on the bit stream. In step 760, media player 210 sets preferences based on the accessory identifier.

In various embodiments, media player 210 may receive one or more bytes of the bit stream at a time for processing. Media player 210 may inspect headers and footers, determine checksums, and engage in further packet processing to determine the accessory identifier based on the bit stream. If media player 210 detects a valid packet or bit stream, media player 210 may stop generating a clock signal or virtual clock to accessory 220. If media player 210 fails to detect a valid packet or bit stream, media player 210 may continue generating the clock signal for a predetermined amount of time in an attempt to detect a valid packet or bit stream. Eventually, media player 210 may give up any attempt to detect a valid packet or bit stream after a predetermined time or threshold, and discontinue generation of a clock signal or virtual clock to drive accessory 220. FIG. 7 ends in step 770.

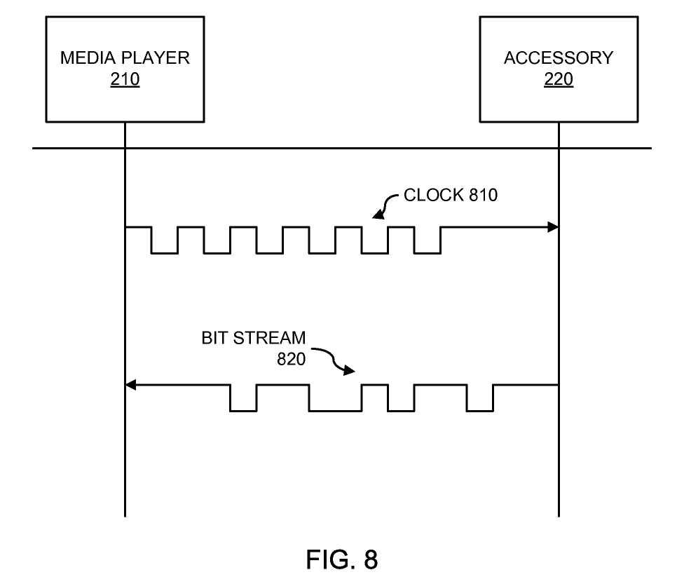

FIG. 8 is a message sequence chart illustrating communication for identification using a bit stream in one embodiment according to the present invention. In this example, media player 210 may see or otherwise detect the “Extended Identification Resistor” value when coupled to accessory 220. Media player 210 may transmit a clock signal 810. For example, media player 210 may transmit repeating “0x55” data pulses over TX port 270 of communication interface 230 to provide an oscillating signal. The “0x55” pulse can have the waveform shape and duty cycle of a clock signal, being similar to a square wave.

Accessory 220 may include secondary identification circuitry 250 that has an integrated circuit. The integrated circuit may include control circuitry configured to transmit identification information stored in a memory in response to a clock signal that implements a shift-register state machine (e.g., see FIG. 6). The shift register may include programmable or hard-wired input values that are loaded during power-up. Using clock signal 810 (e.g., “0x55” data pulse), media player 210 may clock out bit stream 820, bit by bit, as a binary number or packet from the shift registers. The value of the binary number or packet may be the identification value or Extended Identification Tag of accessory 220.

In some embodiments, a protocol scheme may dictate the format of the outgoing bits from accessory 220 to media player 210. This may allow media player 210 to distinguish beginning, length, and endpoint of the bit stream. The protocol may further ensure that the packets clocked out of accessory 220 may be properly formatted, for example, to be hardware UART compatible. Furthermore, the protocol may provide the proper trigger of appropriate actions in media player 210, along with the recovery if a bit is missed, or if a device resets itself mid-stream.

Accordingly, a device identification scheme can be implemented cost effectively in simple accessories or peripheral devices while also maintaining compatibility with existing electronic devices that include serial communication links. Additionally, the scheme may be used as an extension to current identification methods by implementing the scheme to be fully UART compliant. Therefore, through software updates, a like configured media player or portable media device could be made to identify accessories without modification to their hardware.

Moreover, the nature of the serial communication link as discussed above can provide a large number of additional accessory “bins” expanding the number of accessories or other peripheral devices that may be recognized. Additionally, the scheme may be used by simple devices, such as those lacking a microcontroller. Therefore, identification circuitry in various embodiment may be implemented in a very small package size, having reduced complexity and cost, while allowing compatibility with electronic devices without hardware modification.

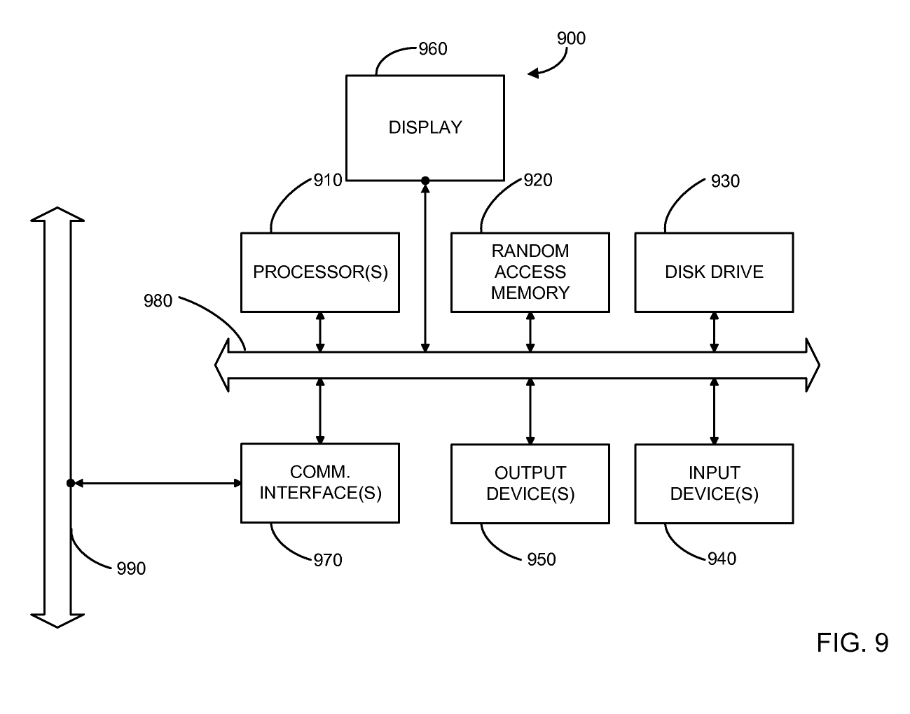

FIG. 9 is a simplified block diagram of a computer system 900 that may incorporate embodiments of the present invention. FIG. 9 is merely illustrative of an embodiment incorporating the present invention and does not limit the scope of the invention as recited in the claims. One of ordinary skill in the art would recognize other variations, modifications, and alternatives.

In one embodiment, computer system 900 includes processor(s) 910, random access memory (RAM) 920, disk drive 930, input device(s) 940, output device(s) 950, display 960, communications interface(s) 970, and a system bus 980 interconnecting the above components. Other components, such as file systems, storage disks, read only memory (ROM), cache memory, codecs, and the like may be present.

RAM 920 and disk drive 930 are examples of tangible media configured to store data such as audio, image, and movie files, operating system code, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In various embodiments, input device 940 is typically embodied as a computer mouse, a trackball, a track pad, a joystick, a wireless remote, a drawing tablet, a voice command system, an eye tracking system, a multi-touch interface, a scroll wheel, a click wheel, a touch screen, an FM/TV tuner, audio/video inputs, and the like. Input device 940 may allow a user to select objects, icons, text, and the like, via a command such as a click of a button or the like. In various embodiments, output device 950 is typically embodied as a display, a printer, a force-feedback mechanism, an audio output, a video component output, and the like. Display 960 may include a CRT display, an LCD display, a Plasma display, and the like.

Embodiments of communications interface 970 may include computer interfaces, such as include an Ethernet card, a modem (telephone, satellite, cable, ISDN), (asynchronous) digital subscriber line (DSL) unit, FireWire interface, USB interface, and the like. For example, these computer interfaces may be coupled to a computer network 990, to a FireWire bus, or the like. In other embodiments, these computer interfaces may be physically integrated on the motherboard or system board of computer system 900, and may be a software program, or the like.

In various embodiments, computer system 900 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer system 900 may also include an operating system, such as Microsoft Windows®, Linux®, Mac OS X®, real-time operating systems (RTOSs), open source and proprietary OSs, and the like.

FIG. 9 is representative of a media player and/or computer system capable of embodying the present invention. It will be readily apparent to one of ordinary skill in the art that many other hardware and software configurations are suitable for use with the present invention. For example, the media player may be a desktop, portable, rack-mounted or tablet configuration. Additionally, the media player may be a series of networked computers. Moreover, the media player may be a mobile device, an embedded device, a personal digital assistant, a smart phone, and the like. In still other embodiments, the techniques described above may be implemented upon a chip or an auxiliary processing board.

The present invention can be implemented in the form of control logic in software or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The embodiments discussed herein are illustrative of one or more examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for operating an accessory device for identifying the accessory device to electronic devices, the method comprising:
receiving at an accessory device an initiation pulse from an electronic device using a serial communication link, the initiation pulse indicating to the accessory device to respond with identification information using the serial communication link; and
generating at the accessory device an identification pulse using the serial communication link, wherein the electronic device identifies the accessory device based on the identification pulse.

2. The method of claim 1 wherein generating the identification pulse comprises transmitting a single pulse using the serial communication link.

3. The method of claim 1 wherein generating the identification pulse comprises outputting a pre-determined voltage using the serial communication link for a pre-determined period.

4. The method of claim 1 further comprising transmitting the identification pulse to the electronic device using the serial communication link.

5. The method of claim 1 further comprising presenting information to the electronic device indicating that the accessory device supports identification using the serial communication link.

6. An accessory device for use with an electronic device, the accessory device comprising:
an input port;
an output port; and
an identification circuit configured to:
receive via the input port an initiation pulse from the electronic device using a serial communication link, the initiation pulse indicating to the identification circuit to respond with identification information using the serial communication link, and
generate an identification pulse such that electronic device identifies the accessory device from the identification pulse using the serial communication link.

7. The accessory device of claim 6 wherein the identification circuit is configured to generate the identification pulse as a single pulse.

8. The accessory device of claim 6 wherein the identification circuit is configured to generate the identification pulse at a pre-determined voltage for a pre-determined period.

9. The accessory device of claim 6 wherein the identification circuit is further configured to output via the output port the identification pulse to the electronic device using the serial communication link.

10. The accessory device of claim 6 further comprising one or more resistors configured to generate a predetermined resistor value to present information to the electronic device that the accessory device supports identification using a serial communication link.

11. The accessory device of claim 6 wherein the identification circuitry includes a timer.

12. The accessory device of claim 6 wherein the identification circuitry includes a mono-stable multivibrator.

13. The accessory device of claim 6 wherein the accessory device comprises an audio cable, a video cable, a docking station, a FM tuner, a TV tuner, or a voice recorder.

14. An integrated circuit for generating identification information, the integrated circuit comprising:
pulse detection circuitry configured to detect an initiation pulse sent using a serial communication link;
pulse generation circuitry configured to generate an identification pulse using the serial communication link; and
control circuitry configured to send identification information via the pulse generation circuitry using the serial communication link in response to a detection by the pulse detection circuitry.

15. The integrated circuit of claim 14 wherein the pulse generation circuitry is configured to generate the identification pulse as a single pulse.

16. The integrated circuit of claim 14 wherein the pulse generation circuitry is configured to generate the identification pulse at a pre-determined voltage for a pre-determined period.

17. The integrated circuit of claim 14 further comprising:
an input pin; and
an output pin;
wherein the pulse detection circuitry is further configured to receive the initiation pulse via the input pin;
wherein the pulse generation circuitry is further configured to output the identification pulse via the output pin.

18. The integrated circuit of claim 14 further comprising:
scheme detect circuitry configured to present information indicating support for an identification scheme using the serial communication link.

19. The integrated circuit of claim 14 wherein the pulse generation circuitry includes a timer circuit.

20. The integrated circuit of claim 14 wherein the pulse generation circuitry includes a mono-stable multivibrator circuit.

21. A method for operating a media player having a serial communications interface, the method comprising:
determining whether an accessory device coupled to the media player supports identification using a serial communication link;
generating an initiation pulse using the serial communication link, the initiation pulse indicating to the identification circuit to respond with identification information using the serial communication link;
receiving from the accessory device an identification pulse using the serial communication; and
identifying the accessory device based on the identification pulse.

22. The method of claim 21 wherein identifying the accessory device further comprises:
determining characteristics of the identification pulse; and
identifying the accessory device based on the characteristics of the identification pulse.

23. The method of claim 21 wherein identifying the accessory device comprises determining an identifier associated with the accessory device based on timing information associated with the identification pulse.

24. The method of claim 21 wherein identifying the accessory device comprises determining an identifier associated with the accessory device based on speed information associated with the identification pulse.

25. The method of claim 21 wherein identifying the accessory device further comprises:
obtaining accessory identification information associated with a plurality of accessory devices; and
matching the identification pulse to accessory identification information associated with at least one of the plurality of accessory devices.

26. The method of claim 21 further comprising transmitting the initiation pulse to the accessory device using the serial communication link.

27. The method of claim 21 further comprising enabling one or more media playback functionalities of the media player in response to identifying the accessory device.

28. The method of claim 21 further comprising detecting the presence of the accessory device at the media player.

29. A portable media device for use with an accessory, the portable media device comprising:
an accessory port;
a communications interface;
a media playback subsystem; and
a processor configured to:
detect the presences of an accessory device when the accessory device is coupled to the accessory port;
determine whether the accessory device supports identification using a serial communication link provide by the communications interface,
generate an initiation pulse using the serial communication link where the initiation pulse indicates to the identification circuit to respond with identification information using the serial communication link,
analyze an identification pulse received from the accessory device using the serial communication,
identify the accessory device based on the identification pulse, and
provide one or more functionalities of the media playback subsystem to the identified accessory device.

30. The portable media device of claim 29 wherein the processor is further configured to:
determine characteristics of the identification pulse; and
identify the accessory device by identifying the accessory device based on the characteristics of the identification pulse.

31. The portable media device of claim 29 wherein the processor is configured to identify the accessory device by determining an identifier associated with the accessory device based on timing information associated with the identification pulse.

32. The portable media device of claim 29 wherein the processor is configured to identify the accessory device by determining an identifier associated with the accessory device based on speed information associated with the identification pulse.

33. The portable media device of claim 29 wherein the processor is further configured to:
obtain accessory identification information associated with a plurality of accessory devices; and
identify the accessory device by matching the identification pulse to accessory identification information associated with at least one of the plurality of accessory devices.

34. The portable media device of claim 29 wherein the processor is further configured to transmit the initiation pulse using the serial communication link to the accessory device via the communications interface.

35. The portable media device of claim 29 wherein the portable media device comprises a handheld or wearable device.

36. A computer-readable storage medium configured to store program code for a media playback device, the computer-readable storage medium comprising:
code for detecting whether an accessory device is coupled to the media playback device;
code for determining whether the accessory device supports identification using a serial communication link;
code for generating an initiation pulse using the serial communication link, the initiation pulse indicating to the identification circuit to respond with identification information using the serial communication link;
code for receiving from the accessory device an identification pulse using the serial communication;
code for identifying the accessory device based on the identification pulse; and
code for providing one or more functionalities of the media playback device to the identified accessory device.

37. A method for operating an accessory device for identifying the accessory device to electronic devices, the method comprising:
receiving at an accessory device a series of data transmission using a serial communication link from an electronic device, the series of data transmission forming a clock signal; and
transmitting identification information from the accessory device using the serial communication link in response to the clock signal on the serial communication link, wherein the electronic device identifies the accessory device based on the identification information.

38. The method of claim 37 wherein transmitting the identification information comprises transmitting a bit stream using the serial communication link in response to the clock signal.

39. The method of claim 38 wherein transmitting the bit stream comprises shifting onto the serial communication link a set of pre-determine bits using a shift register.

40. The method of claim 37 further comprising presenting information to the electronic device indicating that the accessory device supports identification using the serial communication link in response to a clock signal on the serial communication link.

41. An accessory device for use with an electronic device, the accessory device comprising:
an input port;
an output port; and
an identification circuit configured to:
receive via the input port a series of data transmission using a serial communication link from an electronic device, the series of data transmission forming a clock signal, and
generate identification information in response to the clock signal such that the electronic device identifies the accessory device based on the identification information using the serial communication link.

42. The accessory device of claim 41 wherein the identification circuit is configured to transmit the identification information as a bit stream using the serial communication link.

43. The accessory device of claim 42 wherein the identification circuit further includes a shift register configured to transmit the bit stream by shifting onto the serial communication link a set of pre-determine bits.

44. The accessory device of claim 41 wherein the identification circuit is further configured to output via the output port the identification information to the electronic device using the serial communication link.

45. The accessory device of claim 41 further comprising accessory detect circuitry configured to present information to the electronic device indicating that the accessory device supports identification using the serial communication link in response to a clock signal on the serial communication link.

46. The accessory device of claim 45 wherein the accessory detect circuitry includes one or more resistors configured to generate a predetermined resistor value.

47. The accessory device of claim 45 wherein the accessory device comprises an audio cable, a video cable, a docking station, a FM tuner, a TV tuner, or a voice recorder.

48. An integrated circuit for generating identification information, the integrated circuit comprising:
a memory configured to store identification information;
control circuitry configured to transmit the identification information stored in the memory using a serial communication link; and
a clock input configured to receive a clock signal generated by data transmissions of an electronic device using the serial communication link to drive the control circuitry.

49. The integrated circuit of claim 48 wherein the control circuitry is configured to transmit the identification information as a bit stream using the serial communication link.

50. The integrated circuit of claim 48 wherein the control circuitry includes a shift register configured to transmit the bit stream by shifting onto the serial communication link a set of pre-determine bits.

51. The integrated circuit of claim 48 further comprising:
an input pin; and
an output pin;
wherein the control circuitry is further configured to receive via the input pin the clock signal using the serial communication link
wherein the control circuitry is further configured to output via the output ping the identification information to the electronic device using the serial communication link.

52. The integrated circuit of claim 48 further comprising scheme detect circuitry configured to present information to the electronic device indicating support for an identification scheme using a serial communication link in response to a clock signal on the serial communication link.

53. A method for operating a media player having a serial communications interface, the method comprising:
determining whether an accessory device coupled to the media player supports identification using a serial communication link;
generating using the serial communication link a series of data transmissions forming a clock signal;
receiving from the accessory device identification information using the serial communication link transmitted in response to the clock signal sent using the serial communication link; and
identifying the accessory device based on the identification information.

54. The method of claim 53 wherein receiving the identification information comprises receiving a bit stream representing the identification information.

55. The method of claim 53 wherein identifying the accessory device comprises determining an identifier associated with the accessory device based on the identification information.

56. The method of claim 53 wherein identifying the accessory device further comprises:
obtaining accessory identification information associated with a plurality of accessory devices; and
matching the identification information to accessory identification information associated with at least one of the plurality of accessory devices.

57. The method of claim 53 further comprising enabling one or more media playback functionalities of the media player in response to identifying the accessory device.

58. The method of claim 53 further comprising detecting the presence of the accessory device at the media player.

59. A portable media device for use with accessory devices, the portable media device comprising:
an accessory port;
a communications interface;
a media playback subsystem; and
a processor configured to:
detect the presence of an accessory device when the accessory device is coupled to the accessory port;
determine whether the accessory device supports identification using a serial communication link provide by the communications interface,
generate using the serial communication link a series of data transmissions forming a clock signal,
receive identification information transmitted from the accessory device using the serial communication link in response to the clock signal sent using the serial communication link,
identify the accessory device based on the identification information, and
provide one or more functionalities of the media playback subsystem to the identified accessory device.

60. The portable media device of claim 59 wherein the processor is further configured to receive the identification information by receiving a bit stream representing the identification information.

61. The portable media device of claim 59 wherein the processor is configured to identify the accessory device by determining an identifier associated with the accessory device based on the identification information.

62. The portable media device of claim 59 wherein the processor is further configured to:
obtain accessory identification information associated with a plurality of accessory devices; and
identify the accessory device by matching the identification information to accessory identification information associated with at least one of the plurality of accessory devices.

63. The portable media device of claim 59 wherein the portable media device comprises a handheld or wearable device.

64. A computer-readable storage medium configured to store program code for a media playback device, the computer-readable storage medium comprising:
code for detecting whether an accessory device is coupled to the media playback device;
code for determining whether the accessory device supports identification using a serial communication link;
code for generating a series of data transmissions using the serial communication link representing a clock signal;
code for receiving from the accessory device a bit stream using the serial communication in response to the clock signal sent using the serial communication link;
code for identifying the accessory device based on the bit stream; and
code for providing one or more functionalities of the media playback device to the identified accessory device.
